(19) United States
(12) Patent Application Publication
(10) Pub. No.: US 2024/0095307 A1
(43) Pub. Date: Mar. 21, 2024

(54) Parameter Aggregation and Normalization for Manufacturing Tools

(71) Applicant: Onto Innovation Inc., Wilmington, MA (US)

(72) Inventor: Joshua Michael Holt, Hillsboro, OR (US)

(21) Appl. No.: 18/466,932

(22) Filed: Sep. 14, 2023

Related U.S. Application Data
(60) Provisional application No. 63/406,956, filed on Sep. 15, 2022.

(51) Int. Cl. G06F 17/18

(52) U.S. Cl. CPC G06F 17/18

(57) ABSTRACT

Management and maintenance of tools. Tool parameters are measured. The measured values are scored according to an index. In some examples, indexed scores can be aggregated. The indexed and/or aggregated scores can be used to quickly check status of tools and identify for which tools maintenance or remediation may be required. A dashboard interface can be provided for navigating among tools or systems based on their indexed scores. Maintenance and/or remediation measures for one or more tools can then be implemented as needed.

### CROSS-REFERENCE TO RELATED APPLICATION

This application claims the benefit of U.S. Provisional Application No. 63/406,956 filed Sep. 15, 2022, the contents of which are hereby incorporated by reference in their entirety.

### FIELD OF DISCLOSURE

The present disclosure is directed to component manufacturing and managing performance of tools involved in the manufacturing process, including semiconductor manufacturing processes.

### BACKGROUND

Semiconductor substrates are manufactured or fabricated as part of the formation of semiconductor chips or other types of integrated circuits (ICs). The components of the ultimate IC may be incorporated into the substrate through a series of fabrication steps. The fabrication steps may include deposition steps where a thin film layer is added onto the substrate. The substrate then may be coated with a photoresist and the circuit pattern of a reticle may be projected onto the substrate using lithography techniques. Etching processes, with etching tools may then occur.

For the completed substrate (e.g., a wafer, or a wafer lot) to be usable, each tool involved in the substrate fabrication process must perform within a predefined acceptable operation tolerance for the aspect of the substrate for which that tool is responsible. Tool performance can depend on factors outside of the tools themselves, such as environmental conditions (e.g., ambient light, ambient noise, dust, moisture, and so forth). Inspection tools and measuring tools are used as part of the manufacturing process to ensure that the completed substrate meets a predefined specification. If even a single tool in the fabrication process is performing outside of its tolerance, a defect in the substrate of sufficient magnitude can result that requires all of the wafers in that run or subsequent fabrication run to be scrapped, at potentially significant cost.

### SUMMARY

In general terms, the present disclosure is directed to monitoring and/or maintenance of manufacturing tools, which can include, for example, robotics, fabrication tools, inspection tools, and/or measuring (e.g., metrology) tools.

In further general terms, the present disclosure is directed to improving consistency of performance across manufacturing tools of the same type. For example, a given fabrication facility or group of facilities may have multiple tools that perform the same fabrication step. Even if all of those tools are within specification, there can be discrepancies in performance from tool to tool, which can disadvantageously result in inconsistencies across the completed wafers produced by the facility. Moreover, such inconsistencies can be magnified by performance inconsistences of other tools involved at other times (e.g., later) in the fabrication process.

According to certain aspects, the present disclosure is directed to measuring a value of a parameter associated with a manufacturing tool and indexing the measured value to an index, e.g., by normalizing the measured value.

According to certain aspects, the present disclosure is directed to measuring values of parameters associated with multiple manufacturing tools and indexing the measured values to a single index, e.g., by normalizing the measured values.

According to certain aspects, the present disclosure is directed to measuring values of parameters associated with multiple manufacturing tools, indexing the measured values to a single index, and aggregating the indexed values into a single composite value or score. The composite score can represent a health or other status of a system, a subsystem, or any number of tools.

Features of the present disclosure can be implemented as systems, methods (including computer-implemented methods), and as instructions stored on non-transitory computer readable storage.

While the present disclosure may refer in specific examples to specific types of manufacturing tools, such as substrate fabrication tools, the features of the present disclosure can be readily applied to other manufacturing tools that perform other functions.

Features of the present disclosure can be readily applied to tools and systems other than those involved in semiconductor substrate manufacturing. For example, parameter indexing, normalization and aggregation for tools, as described herein, can be applied to tools and systems that are not involved in processes other than semiconductor substrate manufacturing and metrology.

According to certain specific aspects, the present disclosure is directed to a method for evaluating at least one tool, including: measuring a first value of a first parameter associated with a performance of the at least one tool; measuring a second value of a second parameter associated with the performance of the at least one tool; mapping, with a first mapping function, the first value to an index to provide a first mapped parameter value; mapping, with a second mapping function that is different from the first mapping function, the second value to the index to provide a second mapped parameter value; and aggregating, with an aggregating function, the first mapped parameter value and the second mapped parameter value to provide an aggregated performance score for the at least one tool.

According to further specific aspects, the present disclosure is directed to a method for evaluating a first tool and a second tool, including: measuring a first value of a first parameter associated with a performance of the first tool; measuring a second value of a second parameter associated with a performance of the second tool, the first parameter not being associated with the second tool, the second parameter not being associated with the first tool; mapping the first value to an index to provide a first mapped parameter value; mapping the second value to the index to provide a second mapped parameter value; and aggregating the first mapped parameter value and the second mapped parameter value to provide an aggregated performance score for a combination of the first tool and the second tool.

According to further specific aspects, the present disclosure is directed to system for evaluating at least one tool, including: at least one processor; and non-transitory computer-readable memory having stored thereon instructions which, when executed by the at least one processor, causes the at least one processor to: measure a first value of a first parameter associated with a performance of the at least one tool; measure a second value of a second parameter associated with the performance of the at least one tool; map, with a first mapping function, the first value to an index to provide a first mapped parameter value; map, with a second mapping function that is different from the first mapping function, the second value to the index to provide a second mapped parameter value; and aggregate, with an aggregating function, the first mapped parameter value and the second mapped parameter value to provide an aggregated performance score for the at least one tool.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 schematically depicts an example system for managing performance of one or more semiconductor manufacturing tools in accordance with the present disclosure.

FIG. 2 schematically depicts a tool system hierarchy for which the system of FIG. 1 can be applied.

FIG. 3 depicts a method of tool monitoring, management, and/or maintenance using the system of FIG. 1.

FIG. 4 summarizes a method that can be performed using the system of FIG. 1.

FIG. 5 depicts a portion of an example user interface that can be generated by the system of FIG. 1.

FIG. 6 depicts a portion of a further example user interface that can be generated by the system of FIG. 1

FIG. 7 depicts a portion of a further example user interface that can be generated by the system of FIG. 1.

### DETAILED DESCRIPTION

Examples of the present disclosure describe systems, methods, and computer-readable products for improving tool management and maintenance. Examples of the present disclosure describe systems, methods, and computer-readable products for monitoring and adjusting performance of manufacturing tools in a variety of factory settings. One example is semiconductor manufacturing tools used in the manufacture of semiconductor substrates.

An example of such a substrate is semiconductor wafer, made up of dies. A given wafer has a yield, which can refer to the percentage of dies of the substrate that would meet one or more defined operational, quality, or other acceptability criteria. Defects in the wafer caused by fabrication tools performing outside of specification can reduce the yield of the wafer. Depending on the yield and/or type, number and/or severity of defects in the wafer, a wafer, or even an entire lot of wafers from a given fabrication run may have to be discarded, which is costly.

Substrate inspection and measuring tools that fall outside of specification can cause similar problems, for example, by identifying defects in wafers or in other tools that are not present, and/or failing to identify defects in wafers or in other tools that are present.

Tool performance can depend on numerous parameters. Some parameters can be specific to the tool, for example, parameters that reflect how different aspects of the tool are calibrated. Some parameters can be environmental parameters under which the tool operates, such as temperature, humidity, ambient light, ambient noise, dust level, vacuum quality, and so forth. Some parameters can be specific to different aspects (e.g., subsystems) of a tool, such as a particular piece of hardware for a given tool. Some parameters can be outputs or measurement results that the tool generates.

Traditionally, equipment troubleshooting starts with a failure or excursion problem statement that initiates a root cause component analysis and action plan. In contrast, according to the present disclosure, a problem statement is inferred from a large pool of component data. Advantageously, by adopting the inferential approach of the present disclosure, it is not necessary to wait for an excursion from acceptable operation to occur within a fleet of tools before diagnosing a problem. Rather, measurements of the underlying subsystem parameters can be effective predictive indicators of tool functionality and performance.

By adopting the inferential approach and fleet performance visualizations of the present disclosure, manufacturing quality can be better controlled because issues can be more easily identified and remediated before they become critical. In addition, the present disclosure can provide for enhancements in functional monitoring of tools, tool-to-tool matching, and fleet performance analytics.

The aggregation techniques of the present disclosure advantageously provide for easily digestible and navigable visualizations of a tool fleet's condition, which can be used to predict future tool performance, metrology results, and the like.

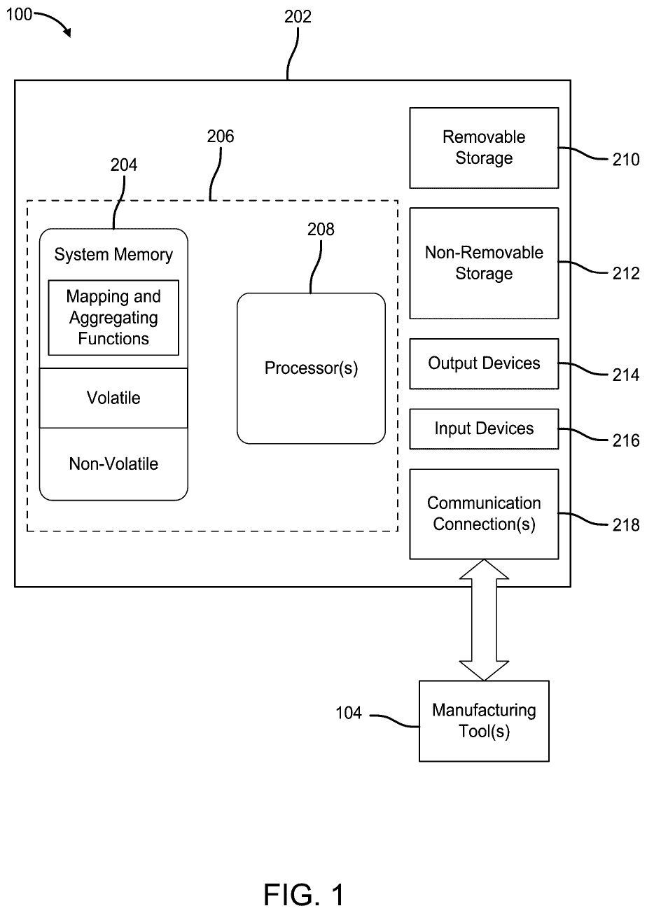

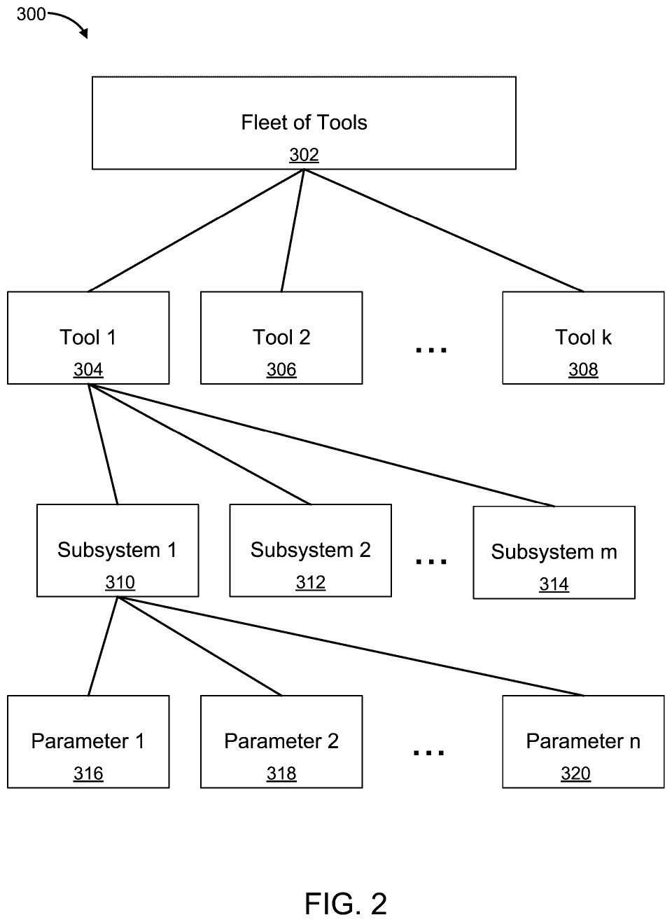

FIG. 2 schematically depicts a tool system hierarchy 300 for which the system 100 of FIG. 1 can be applied. In some examples, the system hierarchy 300 can reflect a hierarchy of semiconductor manufacturing tools, such as manufacturing tools associated with a given fabrication facility or multiple facilities operated by the same enterprise.

Referring to FIG. 2, the hierarchy 300 includes a fleet 302 of tools. The fleet 302 includes individual tools, including tools 304, 306 and 308 (Tool 1 through Tool k, where k is a positive integer).

The tools 304, 306 and 308 can be of different types. For example, one of the tools can be a deposition tool, another of the tools can be an etching tool, another of the tools can be a lithography tool, another of the tools can be a metrology tool, another of the tools can be a coating tool, and so forth. In some examples, two or more of the tools 304, 306, 308 can be the same type of tool and used to perform the same type of function.

Each tool can consist of one or more subsystems, such as the subsystems 310, 312, 314 (Subsystem 1 through Subsystem m, where m is a positive integer). Each subsystem can include hardware, software, firmware, or some combination thereof that, in some examples, can be specific to that subsystem. For example, a stage of a tool, where the stage supports a wafer in progress, can be a subsystem of that tool. As another example, an environmental aspect of a tool (e.g., the ambient light or ambient noise at the tool) can be a subsystem of that tool. As another example, a vacuum chamber of a tool can be a subsystem of that tool. As another example, a heating lamp or cooling system of a tool can be a subsystem of that tool. As another example, a software module that runs an operational aspect of a tool can be a subsystem of that tool. In addition, though not depicted in FIG. 2, subsystems can be nested. As an example, an optical measurement subsystem can contain multiple subsystems, such as a source laser subsystem, a polarizer subsystem, and a detector subsystem.

Each subsystem can be measured according to parameters, such as parameters 316, 318 and 320 (Parameter 1 through Parameter n, where n is a positive integer). Each parameter reflects some aspect of the corresponding subsystem of the corresponding tool. Different tools and different subsystems can have different parameters. Non-limiting examples of parameters can include a temperature, a light intensity, whether a fan or motor is functional, a stage wobble, an amount of available memory, a substance flow rate, an angle of an implement, a speed of a subsystem of a substrate fabrication tool, a previous performance characteristic (e.g., a previously measured thickness or angle of a substrate feature of a fabricated substrate), and so forth.

The value of each parameter at a given time can reflect or provide information on how a tool is performing currently or will perform at a future run. Thus, each parameter can be considered a tool performance parameter. The term “performance” broadly refers to any aspect or condition that directly or indirectly impacts or potentially could impact how the tool operates or will operate or what the tool outputs or will output, regardless of the tool type. Thus, the parameters herein can provide information about tool health, tool status, tool performance, and so forth. The parameters can provide information from which it can be determined that a tool is running properly with no issues, that a tool has relatively minor issues that may require remediation in the near future or within a certain number of future runs of the tool, or that a tool has severe issues that require immediate attention.

Different parameters are measured in different ways, and according to different criteria. For example, a fan can be measured in binary fashion as either operational or non-operational. By contrast, a material deposition tool can have a parameter that is measured based on how thickly it deposits a substrate layer or feature relative to a predefined thickness or range of acceptable thicknesses. Another tool can have a parameter that is measured based on an angle of a feature it creates relative to a predefined angle or range of acceptable angles. Another tool can have a parameter that is measured based on a magnitude of variability of an output of the tool from run to run of the tool and compared to a predefined variability or range of acceptable variability.

Because different parameters are measured and interpreted in different ways, understanding when a problem exists and what is causing the problem in a fleet of tools can be challenging. The present disclosure is directed to normalizing different parameters to a single index and aggregating those parameters such that one index score reflects values of multiple parameters, regardless of whether those parameters are associated with different tools or different subsystems. This can allow for a relatively efficient, holistic understanding of a status or health of a fleet of tools. When the index identifies a potential problem in a fleet, tool or subsystem, a user can then drill down (e.g., via a dashboard interface) within that fleet, tool or subsystem, to identify the specific parameter or parameters whose values are problematic and then adjustments (e.g., servicing, replacing or re-calibrating the corresponding subsystem or tool) can be performed.

FIG. 1 schematically depicts an example system 100 for managing performance of one or more semiconductor manufacturing tools in accordance with the present disclosure.

The system 100 includes a computing device 202. The computing device 202 may be a server and/or other computing device that performs the operations discussed herein, such as the parameter indexing, normalizing, aggregating and visualizing operations described herein. The computing device 202 may include computing components 206. The computing components 206 include at least one processor 208 and memory 204. The memory 204 can include a non-transient computer readable medium. Depending on the exact configuration, the memory 204 (storing, among other things, mapping and aggregating functions and other instructions to perform the other operations disclosed herein) can be volatile (such as RAM), non-volatile (such as ROM, flash memory, etc.), or some combination of the two. The computing device 202 may include one or more graphics processing units (GPUs) configured to generate dashboards and other user interfaces to navigate through parameter hierarchies, such as the hierarchy 300 of FIG. 2, allowing a user to quickly identify which parameters within a fleet may be causing issues now or in the future and how urgently remediation should be implemented.

Further, the computing device 202 may also include storage devices (removable 210, and/or non-removable 212) including, but not limited to, solid-state devices, magnetic or optical disks, or tape. Further, the computing device 202 may also have input device(s) 216 such as touch screens, keyboard, mouse, pen, voice input, etc., and/or output device(s) 214 such as a display, speakers, printer, etc. The input device(s) 216 may be operable to allow a user to navigate a dashboard as described herein. One or more communication connections 218, such as local-area network (LAN), wide-area network (WAN), point-to-point, Bluetooth, RF, etc., may also be incorporated into the computing device 202.

The system 100 can include one or more manufacturing tools 104 that is/are in operative communication with, e.g., linked, via a network and the communications connection(s) 218 to, the computing device 202. Non-limiting examples of such manufacturing tools, in a semiconductor manufacturing context, can include substrate tools, sensor devices, metrology tools and fabrication tools.

A non-limiting example of a metrology tool is a reflectometer or spectrometer that measures intensity of light or other waves (e.g., sound waves) reflected from a substrate at different wavelengths and generates spectra data, from which characteristics of the substrate, such as the thickness of a layer, can be determined. The inspection data includes values of different metrology parameters that can be fed to the computing components 206 as input. The input can then be processed by the computing device 202 to normalize, index, and/or aggregate parameter values, identify issues thereby, and present the issues and the issues' severities via a user interface (such as a dashboard). In some examples, the system memory 204 includes instructions that determine remedial measures that should be performed to remedy issues identified based on the input parameter values, and the remedial measures can be provided to the user via the output device(s) 214.

Non-limiting examples of tool sensor(s) can include temperature sensors, vacuum sensors, light intensity sensors, vibration sensors, ambient light sensors, humidity sensors, optics temperature sensors, fan speed sensors, pressure sensors, flow sensors, electrical current sensors, voltage sensors, and so forth. Data from such sensors can relate to a specific tool parameter, such as the heat or light intensity of the tool's lamp, or the quality of the vacuum chamber generated by the tool. In some examples, data from such sensors can relate to environmental parameters, such as ambient temperature, ambient humidity, ambient light, ambient noise, and so forth. This parameter data can be provided as input to the computing device 202. The input can then be processed by the computing device 202 to normalize, index, and/or aggregate parameter values, identify issues thereby, and present the issues and the issues' severities via a user interface (such as a dashboard) and/or communicate alerts via email, paging, text message, and so forth. In some examples, the system memory 204 includes instructions that determine remedial measures that should be performed to remedy issues identified based on the input parameter values, and the remedial measures can be provided to the user via the output device(s) 214.

Non-limiting examples of fabrication tools can include deposition tools, etching tools, lithography tools, and coating tools. Parameter data provided to the computing device 202 by fabrication tools can include, for example, tool auto-test diagnostic data, calibration data, and run-time data. For example, a fabrication tool can monitor or periodically run a monitoring test on various calibration and other aspects of the tool, such as the alignment of the tool's fabrication stage, a wobble of the tool's fabrication stage, an intensity of a lamp of a tool, a repeatability of an aperture of the tool (e.g., a material deposition aperture or a lens aperture), a video focus of the tool, and so forth. Run-time data is captured for each run of the tool, and can therefore be helpful in identifying and tracking small changes in tool parameter values and when precisely they occur. Examples of run-time data include alignment data and autofocus data for a tool for each fabrication run of the tool. In contrast, auto-test data and calibration data can be captured periodically, e.g., as part of a tool health check process. In some examples, auto-test data and calibration data can include types of parameter performance data that are not monitored or present at each tool run and, therefore, would not be included in run-time data. An example of calibration data includes data relating to a calibration performed by the tool. The parameter data from the fabrication tool(s) can be provided as input to the computing device 202. The input can then be processed by the computing device 202 to normalize, index, and/or aggregate parameter values, identify issues thereby, and present the issues and the issues' severities via a user interface (such as a dashboard), and/or communicate alerts via email, paging, text message, and so forth. In some examples, the system memory 204 includes instructions that determine remedial measures that should be performed to remedy issues identified based on the input parameter values, and the remedial measures can be provided to the user via the output device(s) 214.

In alternative configurations, one or more components of the computing device 202 reside locally on the one or more manufacturing tools 104. For example, one or more manufacturing tools 104 can be configured to themselves perform one or more of the indexing, normalizing, and/or aggregating of parameter values described herein. That is, the indexing, normalizing and aggregating instructions can be run directly on the one or more manufacturing tools 104.

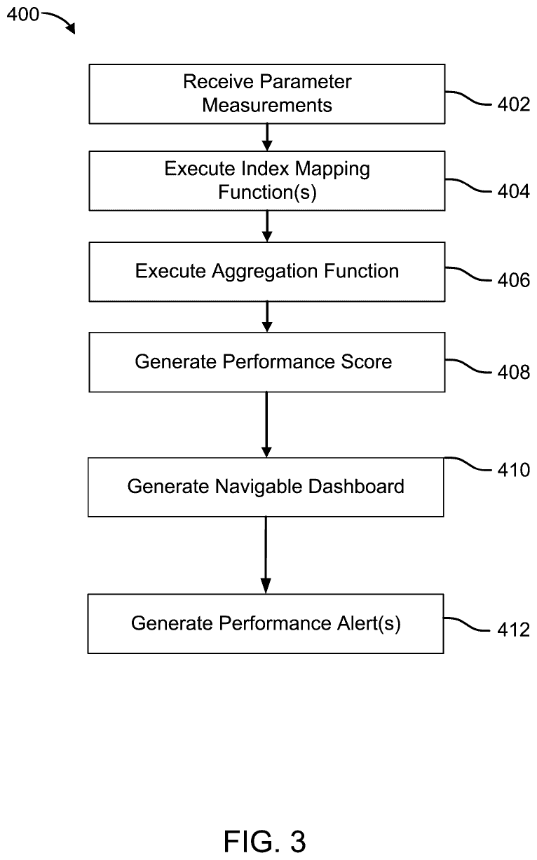

FIG. 3 depicts an example method 400 of tool monitoring, management, and/or maintenance using the system of FIG. 1. In some examples, methods, and systems configured to perform methods, in accordance with the present disclosure need not include every step of the method 400, and/or need not perform the steps in the depicted order of the steps of the method 400.

At a step 402 of the method 400 parameter measurements are made. For example, values of parameters are measured by, e.g., one or more of the manufacturing tools 104 (FIG. 1). The measured parameter values are received by the computing device 202, which then processes the values. The meaning of each parameter value can be specific to that parameter and the corresponding tool. The computing device 202 (FIG. 1) is configured to normalize the disparate parameter values to a single index, such as a health index, status index, or any type of performance index such that the different parameters for different tools can be considered together in a holistic manner. Once normalized, the computing device 202 (FIG. 1) is configured also to aggregate the normalized scores into a single score. In this manner, the health, performance and/or status can be considered quickly and efficiently for multiple parameters, multiple subsystems, and/or multiple tools in a fleet.

More specifically, at a step 404 of the method 400, one or more index mapping functions are performed. In some examples, the step 404 can be performed by the computing device 202. A mapping function can be applied to each parameter value received at the step 402 to map that value to the index. Different mapping functions can be performed for different parameters.

For example, for some parameters the mapping function selected by the computing device 202 can be a Boolean function, where the received parameter value is mapped to either 0 or 100 on a predefined index, such as an index with values ranging on a numeric scale from 0 to 100, with 100 being optimal, 0 being least optimal or catastrophic, and index values increasing in optimization from 0 to 100. For instance, the mapping function can assign a value of 0 if the parameter value means that the parameter is outside of predefined value or range of values, and the mapping function can assign a value of 100 if the parameter value means that the parameter is within the predefined value or range of values. A Boolean type mapping function can be employed, for example, for critical parameters whose failure can cause catastrophic production events, such as fan speed, controller power thresholds, or temperatures. For instance, a cooling fan that is not functioning can be catastrophic, and so the measurement of a malfunctioning cooling fan parameter can be mapped to 0 on the index using a Boolean type mapping function.

For other parameters, the mapping function selected by the computing device can be a function that maps the parameter value to the same predefined index as the other mapping function(s), but according to a distribution, such as a Gaussian distribution. For example, the parameter can be a continuous parameter, at least within predefined parameter value limits, and fall on a bell curve, with the optimal parameter value being at the center, highest point of the bell curve. If the measured parameter value is optimal for that parameter, falling in the center of the bell curve, the parameter value can be mapped to an index value of 100. As the parameter value approaches predefined limits on either side of the center of the curve, the assigned index value decreases from 100 but remains non-zero. If the parameter value falls beyond predefined limits of acceptability on either side of the center of the curve, the assigned index value can be 0, potentially indicating a critical problem that may require immediate remediation. For instance, beam angle of incidence (AOI) can be measured and compared against upper and lower control limits. If the limits are defined as 64.950 and 65.050 degrees respectively and the beam incidence angle is measured at 65.000 degrees, then the measured parameter value is mapped to an index value of 100 on the index. If the AOI is measured at 65.01, then the measured parameter value may be mapped to an index value of 80 on the index. If the AOI is measured at 64.98, the measured parameter value may be mapped to an index value of 60 on the index.

For other parameters, the mapping function selected by the computing device can be a function that maps the parameter value to the same predefined index as the other mapping function(s) based on whether the parameter is within a predefined range (e.g., standard deviation) of a predefined optimal value for that parameter. For example, for a parameter that does not have defined limits of acceptability, such as an oxide matching parameter, it can be beneficial to flag values for that parameter for a given tool that are outliers (e.g., outside of one or two standard deviations) among a population of the same type of tool. Such an outlier can be indicative of an issue requiring remediation, for example, and therefore indexed accordingly (e.g., at 0 on the index, or toward the lower end of the index, depending on the degree to which the value is an outlier).

For other parameters, the mapping function selected by the computing device can be a function that maps the parameter value to the same predefined index as the other mapping function(s) based on historical trending. For example, the parameter value is mapped to the index by comparing the measured value against a running average for that value for that tool, or the running measured average of values for that parameter across a population of the same type of tool. This type of index mapping function can be useful to detect, e.g., a sudden jump or major change from historical performance in a given tool or subsystem, which can be an indication of an issue requiring remediation. For example, the mapping function can be configured such that the further from a historical average is the measured parameter value, the closer the mapped index value is to 0.

Other mapping functions can be used, depending on the parameter. In addition, other configurations for the index itself can be used.

At a step 406 of the method 400, an aggregation function can be executed by the computing device 202 (FIG. 1) on the index scores generated at the step 404. The aggregation function combines the indexed scores of the parameters into a single performance score, which can be generated at the step 408. Because the parameter values for disparate parameters were previously normalized via the mapping functions, the aggregation step 408 is possible.

The aggregating function can be any suitable function that combines the indexed parameter values in a meaningful way. For example, an aggregating function can generate an average of the indexed parameter values or a weighted average of the indexed values. For a weighted average, any suitable weighting factors can be employed. For instance, the indexed values can be weighted based on the age of the corresponding parameter measurements, with older parameter measurements being weighted less, other factors being equal, than more recently measured parameters. Other weighting factors can include the type of tool, with indexed values of parameters of more critical tools being weighted more heavily than those of less critical tools. Further weighting factors are possible.

At a step 410, the results of the steps 404, 406 and/or 408 can be presented via a navigable dashboard user interface. The computing device 202 (FIG. 1) can generate such a dashboard that is displayed in an interactive fashion via the output devices 214 (FIG. 1). From the dashboard, a tool or subsystem that may have an issue requiring remediation can be quickly identified. The dashboard can be configured to allow easy graphical navigation within the subsystem or tool in question down to the parameter level so that the specific parameter(s) causing the issue can be quickly identified, at which point the system 100 (FIG. 1) can recommend a remediation measure to be performed based on the parameter(s) in question. A remediation measure can then be performed. In some examples, the computing device 202 is configured to automatically perform a recommended remediation (e.g., by automatically adjusting a parameter of a tool, pulling a tool out of production (e.g., by making the tool go offline), etc.).

At a step 412, if the performance score indicates that maintenance or remediation may be required on one or more tools, an alert can be automatically generated that provides information about the tool, subsystem or parameter that may require maintenance or remediation based on the indexed score for that component of the fleet. The alert can be an automatically generated alarm, email, voice message, or the like. In some examples, the alert can be provided via the dashboard.

As described herein, the computing device 202 (FIG. 1) is configured, at the step 408, to generate a performance score that represents a composite indicator of overall status, health and/or performance quality of a system (e.g., a system of one or more semiconductor substrate fabrication and/or metrology tools) calculated from an underlying set of disparate values from disparate parameters. The computing device 202 (FIG. 1) normalizes and aggregates measurements of different parameters from one or more manufacturing tools to a single, easy to digest index. The index score allows for quick review of specific tools or suites of tools to determine whether a tool's performance may warrant attention/recalibration, rather than having to look at and interpret measurements of each parameter of each tool individually. The indexed scores can be rolled up into a composite score of the parent system. For example, the index scores of several sensor parameters can be combined to describe the performance (e.g., the health or the status), of a component or subsystem; the indexed scores of multiple subsystems can be weighted and averaged to describe the performance of a tool; and the average indexed score of several tools can describe the performance of a fleet of tools.

The normalizing nature of the index allows tool performance of disparate tools to be visualized together easily. The index can therefore effectively be used to visualize and describe the health of a heterogeneous fleet of different types of tools.

In addition, the systemized approach of the present disclosure can improve consistency of performance across different tools of the same type.

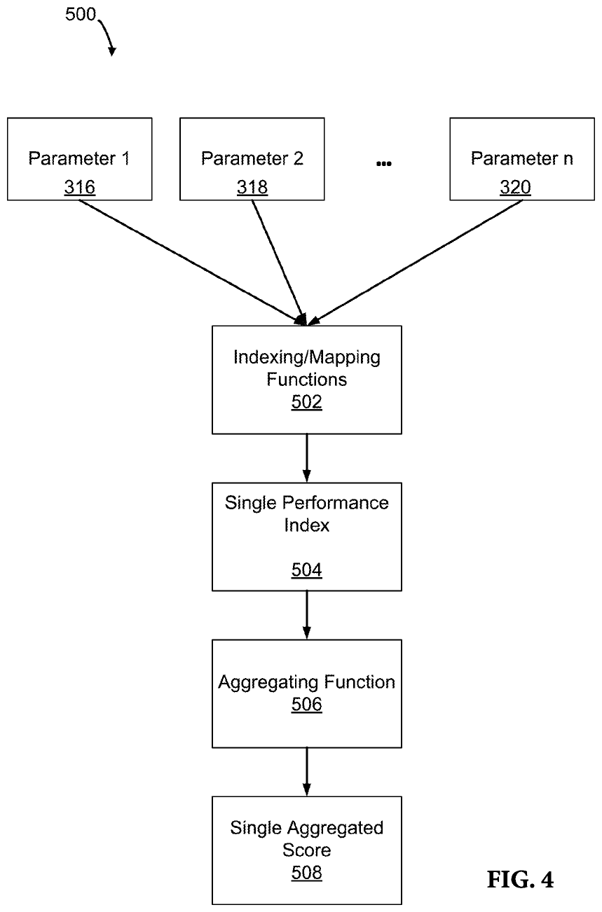

FIG. 4 summarizes a method 500 that can be performed using the system 100 of FIG. 1.

Referring to FIG. 4, according to the method 500, measured values of disparate parameters 316, 318 and 320 are mapped using indexing mapping functions 502 to a single performance index 504. An aggregating function 506 is then executed on the indexed values to generate a single indexed and aggregated score 508 compositely representing the disparate input parameters.

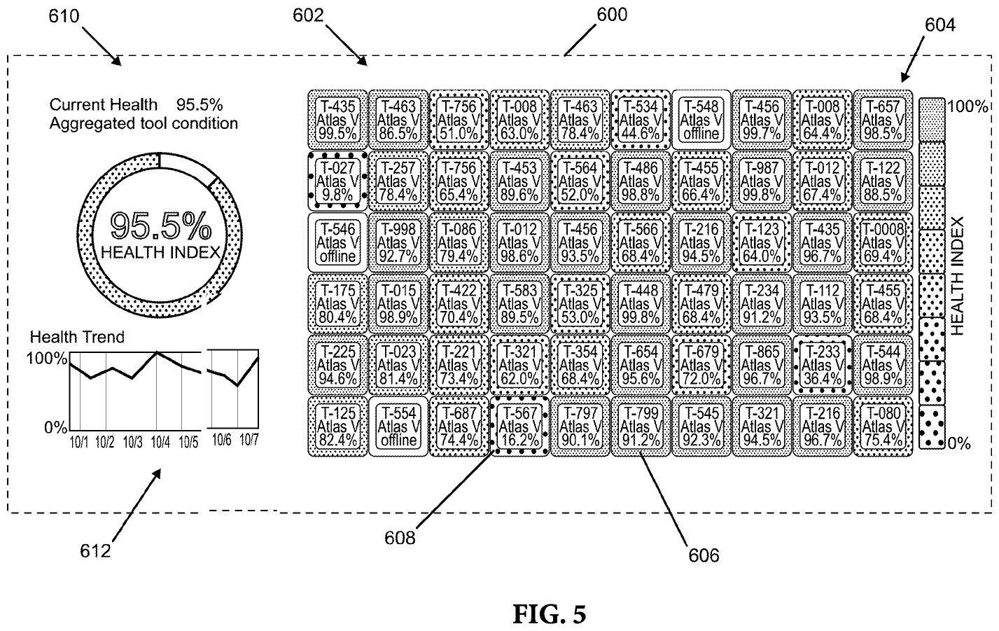

FIGS. 5, 6 and 7 include graphical representations of indexed and/or aggregated performance scores, calculated as described above, for tools within a fleet, subsystems within a tool, and parameters within a subsystem.

FIG. 5 depicts a portion of an example user interface 600 that can be generated by the system 100 of FIG. 1. The interface 600 can be used to navigate and understand a health of a fleet of tools.

Referring to FIG. 5, the interface 600 includes a navigable dashboard including parametric information for a fleet of tools (e.g., a fleet of manufacturing tools). The fleet of tools could be all associated with a single manufacturing facility or with multiple facilities.

The interface 600 includes an array 602 (e.g., a two-dimensional array) of tools that make up the fleet. Each tool in the fleet is graphically represented by a selectable graphical element 606, 608 in the array 602. The graphical elements 606, 608 include indicia that indicate an overall health for each tool. For example, the indicia can include different colors corresponding to different scores of a color-coded health index 604 of the interface 600. Other types if indicia (e.g., different sizes and/or shapes of graphical elements) are possible. The health index 604 ranges from zero to 100. Thus, the color (or other indicia) of each graphical element in the array 602 reflects a composite, indexed health score for that tool.

The indicia can also include a numeric health index score. For example, the graphical element 606 includes a health index score of 91.2 for the corresponding tool, and the graphical element 608 includes a health index score of 16.2 for the corresponding tool.

The interface 600 also includes a graphical health meter 610 that indicates the composite, indexed health score corresponding to the fleet as a whole. In the particular example depicted, the fleet has an overall indexed health score of 95.5. This can facilitate management and maintenance of multiple fleets by, e.g., indicating which fleet or fleets to prioritize remediation for over other fleets, based on their relative overall health scores.

The interface 600 also includes a health trend graphic 612, which indicates how the health of the fleet of tools represented in the array 602 has changed over a period of time, e.g., over several months, days, or weeks. The health trend graphic 612 can be used to identify a fleet that is trending poorly, for example, and therefore may warrant more immediate maintenance or remediation.

Selection of any of the graphical elements of the array 602 can cause the system 100 to generate another user interface corresponding to the tool represented by the selected graphical element.

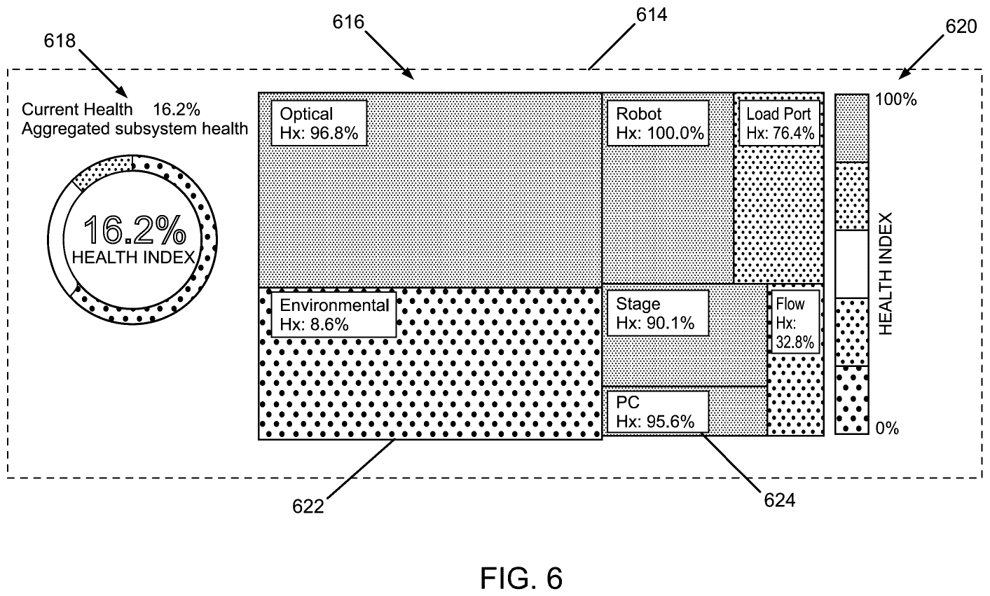

FIG. 6 depicts a portion of a further example user interface 614 that can be generated by the system 100 of FIG. 1. The interface 614 can be generated by selection of the graphical element 608 in FIG. 5. The interface 614 can be used to navigate and understand a health of one or more subsystems of the tool corresponding to the selected graphical element 608 of FIG. 5.

Referring to FIG. 6, the interface 614 includes an array 616 of selectable graphical elements, such as graphical elements 622, 624, with each graphical element in the array representing a different subsystem of the selected tool of the fleet. The graphical elements 622, 624 include indicia that indicate an overall health for each subsystem. For example, the indicia can include different colors corresponding to different scores of the color-coded health index 620 (which is the same index as the index 604 of FIG. 5). Other types if indicia (e.g., different sizes and/or shapes of graphical elements) are possible. The health index 620 ranges from zero to 100. Thus, the color (or other indicia) of each graphical element in the array 616 reflects a composite, indexed health score for that subsystem.

The indicia can also include a numeric health index score. For example, the graphical element 624 includes a health index score of 95.6 for the corresponding subsystem of the selected tool, and the graphical element 622 includes a health index score of 8.6 for the corresponding subsystem of the selected tool.

The interface 614 also includes a graphical health meter 618 that indicates the composite, indexed health score corresponding to the selected tool across all of its subsystems. In the particular example depicted, the selected tool has an overall indexed health score of 16.2. This can facilitate management and maintenance within a fleet of tools by, e.g., indicating which tools to prioritize remediation for within a fleet, based on the tools' relative overall health scores.

Selection of any of the graphical elements of the array 616 can cause the system 100 to generate another user interface corresponding to the subsystem represented by the selected graphical element.

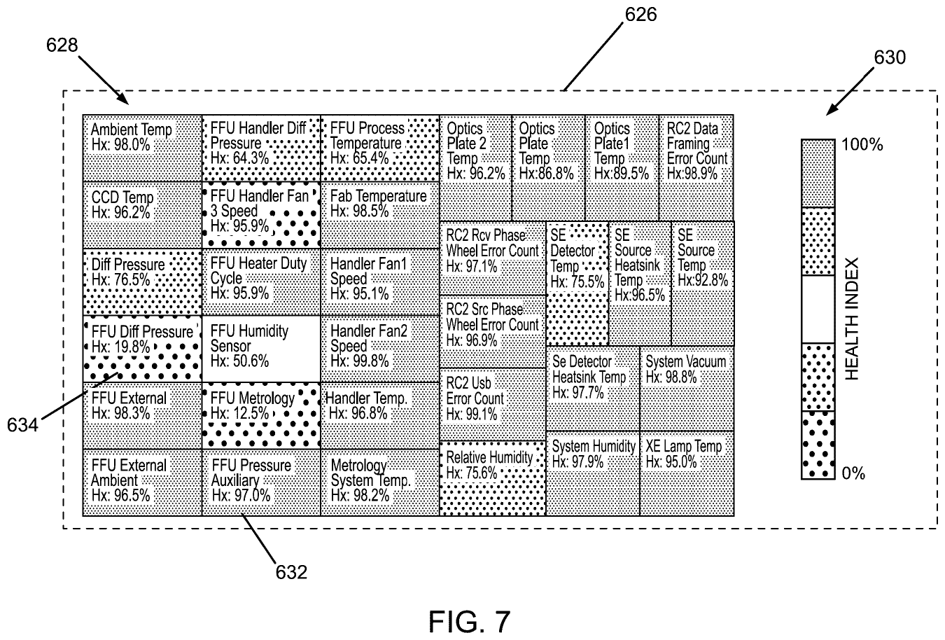

FIG. 7 depicts a portion of a further example user interface 626 that can be generated by the system 100 of FIG. 1. The interface 626 can be generated by selection of the graphical element 622 in FIG. 6. The interface 626 can be used to navigate and understand a health of individual parameters of the tool subsystem corresponding to the selected graphical element 622 of FIG. 6.

Referring to FIG. 7, the interface 626 includes an array 628 of graphical elements, such as graphical elements 632, 634, with each graphical element in the array representing a different parameter of the selected subsystem of the selected tool of the fleet. In some examples, the graphical elements of the array 628 are selectable to generate and display more detailed information about the corresponding parameter. The graphical elements 632, 634 include indicia that indicate an overall health for each parameter. For example, the indicia can include different colors corresponding to different scores of the color-coded health index 630 (which is the same index as the index 604 of FIG. 5). Other types if indicia (e.g., different sizes and/or shapes of graphical elements) are possible. The health index 630 ranges from zero to 100. Thus, the color (or other indicia) of each graphical element in the array 628 reflects a composite, indexed health score for that parameter.

The indicia can also include a numeric health index score. For example, the graphical element 634 includes a health index score of 19.8 for the corresponding parameter of the selected subsystem of the selected tool, and the graphical element 632 includes a health index score of 97.0 for the corresponding parameter of the selected subsystem of the selected tool.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. A method for evaluating at least one tool, comprising:
measuring a first value of a first parameter associated with a performance of the at least one tool;
measuring a second value of a second parameter associated with the performance of the at least one tool;
mapping, with a first mapping function, the first value to an index to provide a first mapped parameter value;
mapping, with a second mapping function that is different from the first mapping function, the second value to the index to provide a second mapped parameter value; and
aggregating, with an aggregating function, the first mapped parameter value and the second mapped parameter value to provide an aggregated performance score for the at least one tool.

2. The method of claim 1, wherein the aggregating includes taking an average or a weighted average of the first mapped parameter value and the second mapped parameter value.

3. The method of claim 1,
wherein the first mapping function includes one of:
(i) an application of a Boolean function corresponding to the at least one tool;
(ii) a comparison to a first distribution of previously measured parameter values corresponding to only one of the at least one tool;
(iii) a comparison to a second distribution of previously measured values corresponding to a plurality of the at least one tool; and
(iv) a comparison against a running average of measured values corresponding to the at least one tool; and
wherein the second mapping function includes another one of (i), (ii), (iii), and (iv).

3. (canceled)

4. The method of claim 1, wherein the aggregating includes taking a weighted average of the first mapped parameter value and the second mapped parameter value based on a type of the at least one tool.

5. The method of claim 1, wherein the first parameter and the second parameter are measured with different measurement techniques.

6. The method of claim 1, wherein only one of the first parameter and the second parameter is binary.

7. A method for evaluating a first tool and a second tool, comprising:
measuring a first value of a first parameter associated with a performance of the first tool;
measuring a second value of a second parameter associated with a performance of the second tool, the first parameter not being associated with the second tool, the second parameter not being associated with the first tool;
mapping the first value to an index to provide a first mapped parameter value;
mapping the second value to the index to provide a second mapped parameter value; and
aggregating the first mapped parameter value and the second mapped parameter value to provide an aggregated performance score for a combination of the first tool and the second tool.

8. The method of claim 7, wherein the aggregating includes taking a weighted average of the first mapped parameter value and the second mapped parameter value based on an age of the first mapped parameter value and an age of the second mapped parameter value.

9. The method of claim 7, wherein the aggregating includes taking a weighted average of the first mapped parameter value and the second mapped parameter value based on a type of the first tool and a type of the second tool.

10. The method of claim 7, further comprising outputting the aggregated performance score to a first graphical user interface of a display, wherein the first graphical user interface includes a plurality of first selectable graphical elements, each first selectable graphical element corresponding to a corresponding unique tool of a plurality of tools and including an indicator indicating a health for the corresponding unique tool.

11. The method of claim 10, wherein selection of each first selectable graphical element causes a second graphical user interface to be generated on the display, the second graphical user interface including a plurality of second selectable graphical elements, each second selectable graphical element corresponding to a corresponding different subsystem of the corresponding unique tool.

12. The method of claim 11, wherein each of the plurality of second selectable graphical elements includes an indicator indicating a health for the corresponding different subsystem of the corresponding unique tool.

13. The method of claim 12, wherein selection of each second selectable graphical element causes a third graphical user interface to be generated on the display, the third graphical user interface including a plurality of third selectable graphical elements, each third selectable graphical element corresponding to a different parameter of the corresponding different subsystem.

14. The method of claim 13, wherein each of the plurality of third selectable graphical elements includes an indicator indicating a health for the corresponding different parameter of the corresponding different subsystem.

15. The method of claim 14, wherein each of the indicator indicating the health for the corresponding different parameter, the indicator indicating the health for the corresponding different subsystem, and the indicator indicating the health for the corresponding unique tool includes a percentage.

16. A system for evaluating at least one tool, comprising:
at least one processor; and
non-transitory computer-readable memory having stored thereon instructions which, when executed by the at least one processor, causes the at least one processor to:
measure a first value of a first parameter associated with a performance of the at least one tool;
measure a second value of a second parameter associated with the performance of the at least one tool;
map, with a first mapping function, the first value to an index to provide a first mapped parameter value;
map, with a second mapping function that is different from the first mapping function, the second value to the index to provide a second mapped parameter value; and
aggregate, with an aggregating function, the first mapped parameter value and the second mapped parameter value to provide an aggregated performance score for the at least one tool.

17. The system of claim 16, wherein to aggregate includes to take an average or a weighted average of the first mapped parameter value and the second mapped parameter value.

18. The system of claim 16,
wherein the first mapping function includes one of:
(i) an application of a Boolean function corresponding to the at least one tool;
(ii) a comparison to a first distribution of previously measured parameter values corresponding to only one of the at least one tool;
(iii) a comparison to a second distribution of previously measured values corresponding to a plurality of the at least one tool; and
(iv) a comparison against a running average of measured values corresponding to the at least one tool; and
wherein the second mapping function includes another one of (i), (ii), (iii), and (iv).

19. The system of claim 16, wherein to aggregate includes to take a weighted average of the first mapped parameter value and the second mapped parameter value based on an age of the first mapped parameter value and an age of the second mapped parameter value.

20. The system of claim 16, wherein to aggregate includes take a weighted average of the first mapped parameter value and the second mapped parameter value based on a type of the at least one tool.

21. The method of claim 1, wherein the aggregating includes taking a weighted average of the first mapped parameter value and the second mapped parameter value based on an age of the first mapped parameter value and an age of the second mapped parameter value.
